(19) United States
(12) Patent Application Publication
(10) Pub. No.: US 2008/0235386 A1
(43) Pub. Date: Sep. 25, 2008

(54) Techniques for Updating Security-Related Parameters for Mobile Stations

(76) Inventor: Paul Oommen, San Diego, CA (US)

Correspondence Address: HARRINGTON & SMITH, PC, 4 RESEARCH DRIVE, SHELTON, CT, 06484-6212, US

(21) Appl. No.: 10/586,014

(22) PCT Filed: Jan. 14, 2005
(86) PCT No.: PCT/US2005/001428

§ 371 Date: Jul. 14, 2006

Related U.S. Application Data
(60) Provisional application No. 60/536,824, filed on Jan. 15, 2004.

(51) Int. Cl. G06F 15/16

(52) U.S. Cl. 709/230

(57) ABSTRACT

A method is performed on a first server for communicating with a mobile station in order for the mobile station to update a security-related parameter. The method includes determining that a request expressed in a first protocol has been made by a second server for updating the security-related parameter on the mobile station. In response to the determination, the request is packaged in a message expressed in a second protocol and is communicated to the mobile station. Another method is disclosed that is performed on a mobile station for updating a security-related parameter. The method includes receiving a message that is expressed in a first protocol from a server and that includes a request for the mobile station to update the security-related parameter. The request is expressed in a second protocol. In response to the message, at least one operation is performed in order to update the security-related parameter.

### TECHNICAL FIELD

This invention relates generally to communication systems and, more specifically, relates to communications with mobile stations.

### BACKGROUND OF THE INVENTION

There are some security-related parameters used in mobile stations, such as mobile stations that use Code Division Multiple Access (CDMA). These security-related parameters can be essential for signaling and data communication for mobile stations. One such security-related parameter is the Authentication Key (A-Key), which is used to authenticate the mobile station and which is implemented as 128-bit key in current generation mobile stations and implemented as a 64-bit key in legacy mobile stations. Because the A-Key is critical to operation of the mobile station within a network, the A-Key is typically called a critical parameter.

In CDMA systems, the A-Key is used for the generation of Shared Secret Data (SSD). The SSD is used for the encryption of data sent in the physical layer as well as layer 2 signaling.

The A-key is different from other parameters for mobile stations, as the A-key is known only to the Authentication Center (AC) and the mobile station. While other parameters may be updated using normal request-response messages, parameters like A-Key require a secure method. The IS-683 standard defines a method for updating A-Key in MSs using messages that use a signaling protocol, such as mobile stations using IS-95 or CDMA2000 networks. The IS-683 standard (e.g., IS-683-A and later revisions) is entitled “Over-the-Air Service Provisioning of Mobile Stations in Spread Spectrum Systems” (1998), the disclosure of which is hereby incorporated by reference. The signaling messages are passed between the mobile station and a server, where the messages are communicated using a signaling protocol and transport implementing the signaling protocol. However, this technique uses signaling messages for updating the A-Key and is hence limited to the specific implementation.

It would therefore be desirable to provide techniques for additional implementations that allow updating of the A-key and other critical parameters for mobile stations.

### BRIEF SUMMARY OF THE INVENTION

The foregoing and other problems are overcome, and other advantages are realized, in accordance with exemplary embodiments of these teachings. In particular, the present invention provides techniques that update security-related parameters for mobile stations using, e.g., Internet Protocol (IP)-based communications.

In an exemplary embodiment of an aspect of the invention, a method is disclosed that is performed on a first server for communicating with a mobile station in order for the mobile station to update a security-related parameter. The method comprises determining that a request expressed in a first protocol has been made by a second server for updating the security-related parameter on the mobile station. In response to the determination, the request is packaged in a message expressed in a second protocol and is communicated to the mobile station.

In another exemplary embodiment, an apparatus is disclosed for communicating with a mobile station in order for the mobile station to update a security-related parameter. The apparatus comprises one or more memories and one or more processors coupled to the one or more memories. The one or more processors are configured to perform the following steps. It is determined that a request expressed in a first protocol has been made by a second server for updating the security-related parameter on the mobile station. In response to the determination, the request is packaged in a message expressed in a second protocol and is communicated to the mobile station.

In yet another exemplary embodiment, another apparatus is disclosed for communicating with a mobile station in order for the mobile station to update a security-related parameter. The apparatus comprises means for determining that a request expressed in a first protocol has been made by a second server for updating the security-related parameter on the mobile station. The apparatus additionally comprises means, responsive to the means for determining, for packaging the request in a message expressed in a second protocol and communicating the message to the mobile station.

In an additional exemplary embodiment, a signal bearing medium is disclosed that tangibly embodies a program of machine-readable instructions executable by a digital processing apparatus to perform operations to communicate with a mobile station in order for the mobile station to update a security-related parameter. The operations comprise determining that a request expressed in a first protocol has been made by a second server for updating the security-related parameter on the mobile station. The operations further comprise, in response to determining, packaging the request in a message expressed in a second protocol and communicating the message to the mobile station.

In another exemplary aspect of the invention, a method is disclosed that is performed on a management server for communicating with a mobile station in order for the mobile station to update a security-related parameter. The method comprises receiving from a second server a first message expressed in a signaling protocol. The first message comprises a first request message. The first request message is expressed in a first data management protocol and defined to request updating the security-related parameter on the mobile station. In response to determining, the first request message is packaged in a second request message expressed in a second data management protocol The second request message is communicated in a second message expressed in an internet protocol to the mobile station.

In an exemplary embodiment of another aspect of the invention, a method is disclosed that is performed on a mobile station for updating a security-related parameter. The method comprises the following steps. A message is received that is expressed in a first protocol from a server and that comprises a request for the mobile station to update the security-related parameter. The request is expressed in a second protocol. In response to the message, at least one operation is performed in order to update the security-related parameter.

In another exemplary embodiment, a mobile station is disclosed that updates a security-related parameter. The mobile station comprises one or more memories and one or more processors coupled to the one or more memories. The one or more processors are configured to perform the following steps. A message expressed in a first protocol is received from a server. The message comprises a request for the mobile station to update the security-related parameter, the request expressed in a second protocol. In response to the message, at least one operation is performed in order to update the security-related parameter.

In a further exemplary embodiment, a mobile station is disclosed that updates a security-related parameter. The mobile station comprises means for receiving a message expressed in a first protocol from a server and comprising a request for the mobile station to update the security-related parameter, the request expressed in a second protocol. The mobile station further comprises means for performing, in response to the message, at least one operation in order to update the security-related parameter.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of a wireless communication system in accordance with an exemplary embodiment of the present invention;

FIG. 2 is a session diagram illustrative of an embodiment of the invention wherein there is an IS-683 client in the mobile station;

FIG. 3 is a session diagram illustrative of an embodiment of the invention wherein the mobile station does not support an IS-683 client; and

FIG. 4 is a block diagram of another wireless communication system in accordance with an exemplary embodiment of the present invention.

### DETAILED DESCRIPTION OF EXEMPLARY EMBODIMENTS

As previously described, there are methods that use signaling for the A-key update. There is significant interest in internet protocol (IP)-based methods for managing mobile stations Over-The-Air (OTA). In fact, corresponding standards work is currently progressing in the Open Mobile Alliance (OMA) and the third Generation Partnership Project (3GPP2). However, current versions of IP-based protocols do not define a method for A-Key exchange or for updating of other security-related parameters in a mobile station.

The present invention solves this problem by providing techniques for updating security-related parameters (e.g., a critical parameter such as the A-Key) for mobile stations using IP-based communications. For instance, an exemplary embodiment of the present invention provides an IP-based method for A-Key update in mobile stations adhering to the CDMA2000 standard. As described above, the A-Key is a critical parameter, which is known only to the Authentication Center (AC) and the mobile station. The exemplary IP-based method can be used for the update of other critical parameters in the mobile station, which are not accessible using normal methods. Another exemplary embodiment is related to the IP-based Over-The-Air (IOTA) Device Management (DM) work item in the 3GPP2 Technical Specification Group for Service and system aspects (TSG-S) standard specification, Project Number 3-0187, Telecommunications Industry Association (TIA)-1059-IP based over the Air Device Management for CDMA2000 Systems. Thus, an exemplary embodiment of this invention provides a method for updating the A-Key in CDMA mobile stations using the IOTA DM framework. Another exemplary embodiment uses the SyncML Device Management Protocol, Version 1.1.2, Approved Version 12, OMA (2003), the disclosure of which is hereby incorporated by reference, for over-the-air device management.

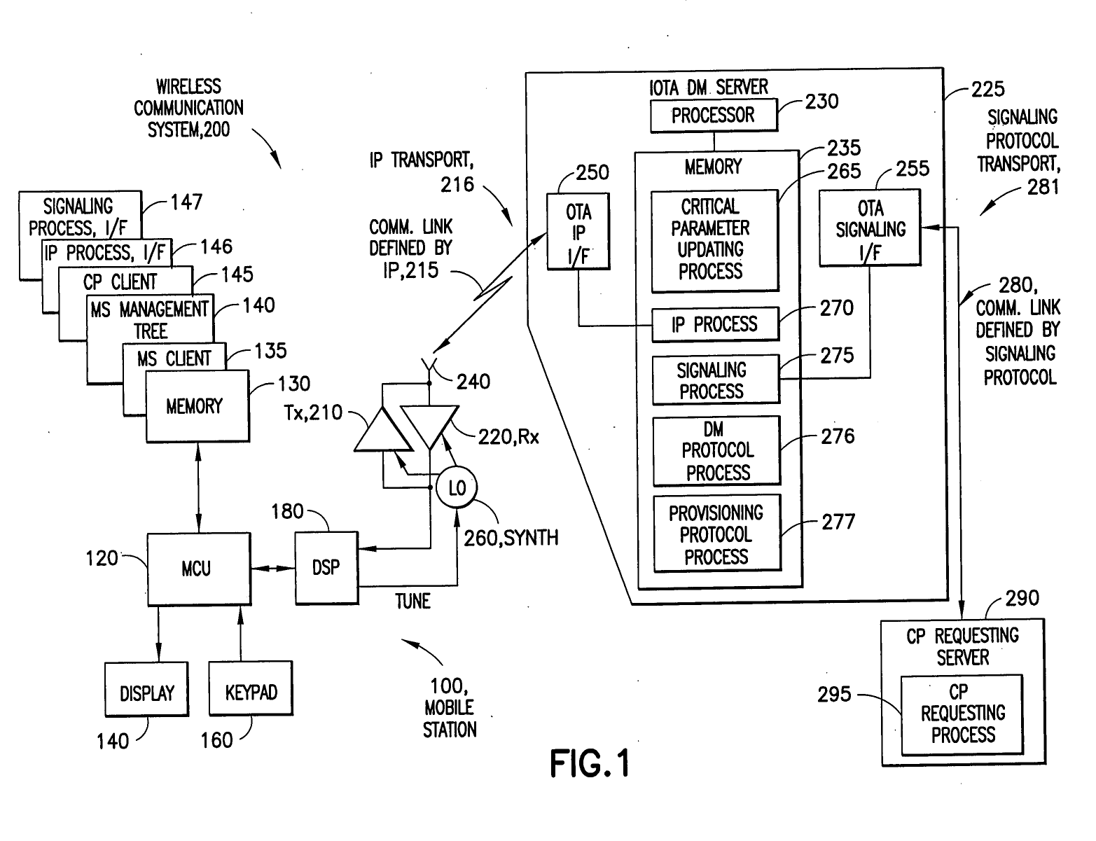

By way of introduction and referring now to FIG. 1, there is shown a simplified block diagram of a wireless communication system 200 that is suitable for practicing exemplary embodiments of the present invention. It should be noted that FIG. 1 is a high-level block diagram and is for illustrative purposes only. Wireless communications system 200 is typically a CDMA system based on the CDMA2000 standard, but could be a communication system operating based on other standards. In the example of FIG. 1, a mobile station 100 is communicating with an IOTA DM server 225 through a communication link defined by an IP 215. The IOTA DM server 225 is communicating with a critical parameter requesting server 290 through a communication link defined by a signaling protocol 280.

The IOTA DM server 225 comprises a processor 230, a memory 235, an OTA IP interface (I/F) 250, and an OTA signaling I/F 255. The memory 235 comprises a critical parameter updating process 265, an IP process 270, a signaling process 275, a DM protocol process 276, and a provisioning protocol process 277. The critical parameter (CP) requesting server 290 comprises a CP requesting process 295. Typically, the CP requesting server 290 would comprise a processor and memory (not shown).

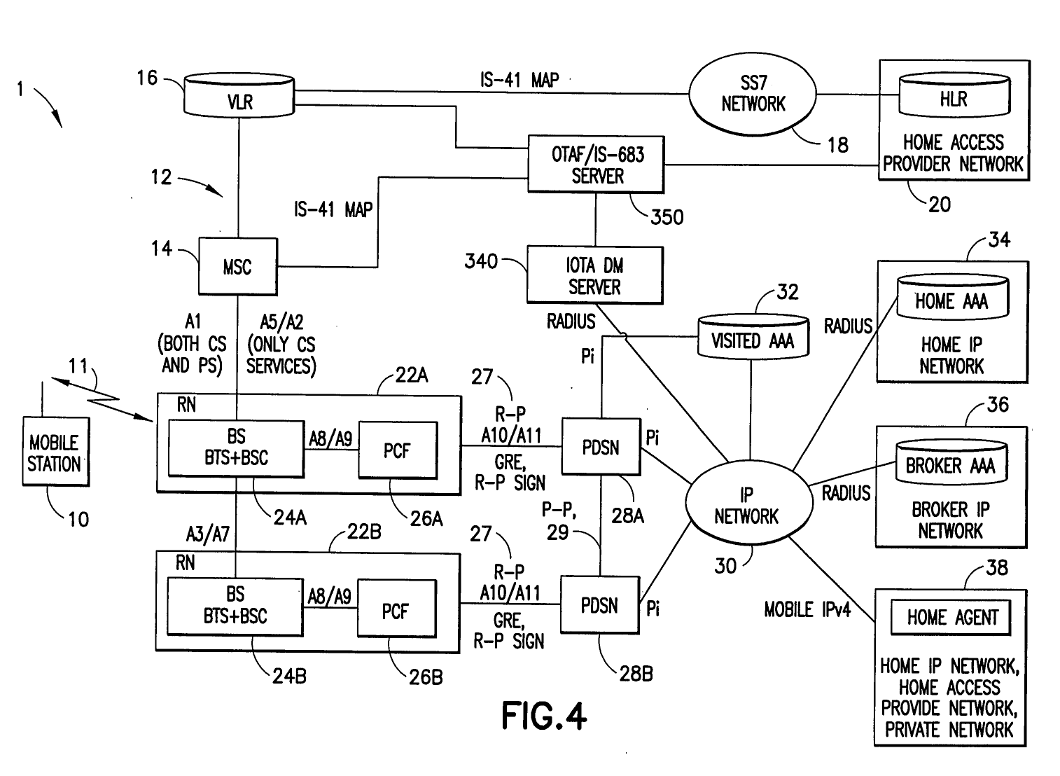

The wireless communications system 200 includes at least one mobile station (MS) 100. The communication link defined by an IP 215 may be completed using at least one base station controller (BSC) or equivalent apparatus, and a plurality of base transceiver stations (BTSs), also referred to as base stations (BSs), that transmit in a forward (e.g., downlink) direction both physical and logical channels to the mobile station 100 in accordance with a predetermined air interface communication protocol, in this case an IP. Note that FIG. 4 shows another example of a communication network that includes BTSs, BSCs, etc. As is known in the art, a communication protocol is a standardized means of communication among machines across a networks The formal description of the protocol is articulated in a standard, such as “Internet Protocol,” Defense Advanced Research Projects Agency (DARPA) Internet Program, Protocol Specification (1981), the disclosure of which is hereby incorporated by reference. A reverse (e.g., uplink) communication path in the communication link defined by an IP 215 also exists from the mobile station 100 to the IOTA DM server 225 and is also defined by an air interface communication protocol, in this case an IP.

Similarly, the communication link defined by a signaling protocol 280 may be completed using at least one BSC or equivalent apparatus, and a plurality of BTSs that transmit in a forward (e.g., downlink) direction both physical and logical channels from the CP requesting server 290 to the IOTA DM server 225 in accordance with a predetermined air interface communication protocol, in this case a signaling protocol. Suitable signaling protocols are described in sections 2.2 (describing signaling using an analog transport protocol) and 2.3 (describing signaling using a CDMA transport protocol) of C.S0016 Over-the-Air Service Provisioning of Mobile Stations in Spread Spectrum Systems, 3GPP2 (March 2003), the disclosure of which is hereby incorporated by reference. A reverse (e.g., uplink) communication path in the communication link defined by a signaling protocol 280 also exists from the IOTA DM server 225 to the CP requesting server 290 and is also defined by an air interface protocol, in this case a signaling protocol.

It should be noted that one or more of the communication link defined by an IP 215 and the communication link defined by a signaling protocol 280 can also be non-over-the-air links, such as hardwired network links.

A cell (not shown) is typically associated with each BTS, where one cell will at any given time be considered to be a serving cell, while an adjacent cell(s) will be considered to be a neighbor cell. Smaller cells (e.g., picocells) may also be available.

The communication link defined by an IP 215 and communication link defined by a signaling protocol 280 can enable both voice and data traffic, and may also include additional protocols. For instance, a message communicated through the communication link defined by an IP 215 could be expressed in both the IP and in a device management protocol such as the SyncML Device Management Protocol, Version 1.1.2, Approved Version 12, OMA (2003). The DM protocol process 276 would support messages sent and received through a device management protocol. Similarly, a message communicated through the communication link defined by a signaling protocol 280 could be expressed in both the signaling protocol and in a provisioning protocol such as the IS-683 standard (e.g., IS-683-A and later revisions), entitled “Over-the-Air Service Provisioning of Mobile Stations in Spread Spectrum Systems” (1998). The provisioning protocol process 277 would support messages sent and received through a provisioning protocol.

Additionally, one single “message” may actually comprise multiple messages. For instance, a message expressed in the IP may contain a message expressed in a data management protocol. For clarity, single messages will be described herein.

It should be noted that provisioning is the ability of carriers to add new types of services to a mobile station by using a wireless network. Similarly, device management allows management of mobile stations though the network. Herein, both provisioning and device management protocols will be considered to fall under the term “management protocols,” as both allow some type of management of the mobile station.

The mobile station 100 typically includes a control unit or control logic, such as a microcontrol unit (MCU) 120 having an output coupled to an input of a display 140 and an input coupled to an output of a keyboard (e.g., keyboard) 160. The mobile station 100 may be a handheld radiotelephone, such as a cellular telephone or a personal communicator. The mobile station 100 could also be contained within a card or module that is connected during use to another device. For example, the mobile station 100 could be contained within a Personal Computer Memory Card International Association (PCMCIA) or similar type of card or module that is installed during use within a portable data processor, such as a laptop or notebook computer, or even a computer that is wearable by the user.

In general, the various embodiments of the mobile station 100 can include, but are not limited to, cellular telephones, personal digital assistants (PDAs), portable computers, image capture devices such as digital cameras, gaming devices, music storage and playback appliances, Internet appliances permitting Internet access and browsing, as well as portable units or terminals that incorporate combinations of such functions.

The MCU 120 is assumed to include or be coupled to some type of a memory 130, including a non-volatile memory for storing an operating program, and other information, as well as a volatile memory for temporarily storing required data, scratchpad memory, received packet data, packet data to be transmitted, and the like. In the example shown in FIG. 1, the memory 130 includes a MS client 135, a MS management tree 140, a CP client 145, an IP process and I/F 146 and a signaling process and I/F 147. The operating program is assumed, for the purposes of this invention, to enable the MCU 120 to execute the software routines, layers and protocols required to implement the methods in accordance with this invention, as well as to provide a suitable user interface (UI), via display 140 and keypad 160, with a user. Although not shown, a microphone and speaker are typically provided for enabling the user to conduct voice calls in a conventional manner.

The mobile station 100 also contains a wireless section that includes a digital signal processor (DSP) 180, or equivalent high speed processor (e.g., or logic or software or some combination of these), as well as a wireless transceiver that includes a transmitter 210 and a receiver 220, both of which are coupled to an antenna 240 for communication with the IOTA DM server 225. At least one local oscillator, such as a frequency synthesizer (SYNTH) 260, is provided for tuning the transceiver. Data, such as digitized voice and packet data, is transmitted and received through the antenna 240.

In a conventional system (e.g., not using an IP for updating of critical parameters), the CP requesting process 295 would request an update to a critical parameter for the mobile station 100. The CP requesting server 290 would then communicate with the mobile station 100 to cause an update of the critical parameter. The requests and communications are performed through a transport that implements a signaling protocol. Broadly, in the present invention, the IOTA DM server 225 “intercepts” requests, based on messages on the transport implementing the signaling protocol, for critical parameter updating. The IOTA DM server 225 then acts as an “intermediary” to update the critical parameter using a transport implementing the IP.

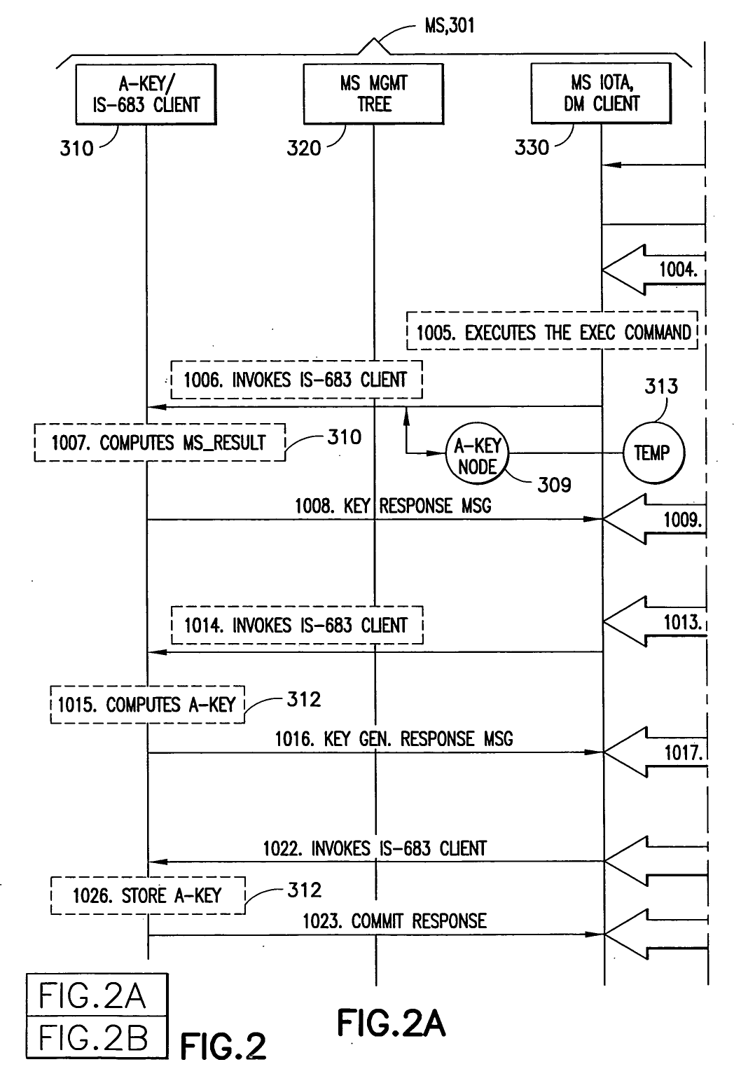

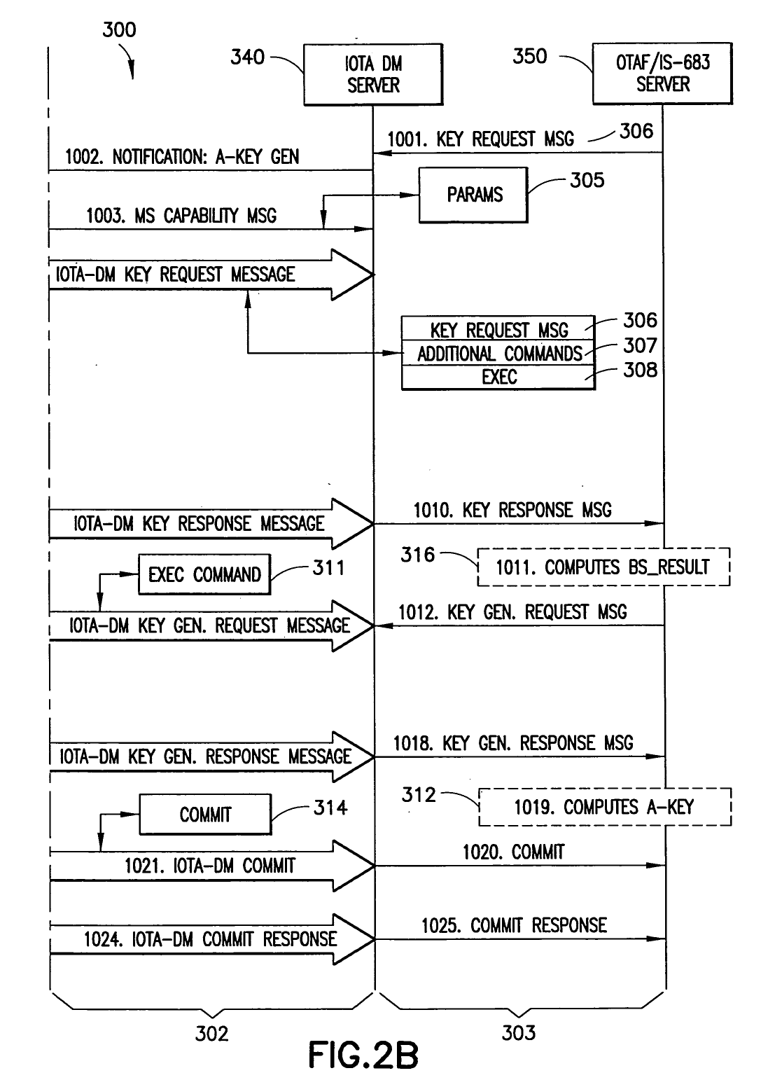

In an exemplary embodiment, the mobile station 100 supports an IS-683 client. The CP requesting server 290 is an OTAF/IS-683 Server and the CP requesting process 295 operates to request updating of the critical parameter (not shown in FIG. 1) and to perform certain computations. In this exemplary embodiment, the CP requesting server 290 also communicates with an AC (not shown in FIGS. 1 or 2), which initiates the critical parameter updating actions. This exemplary embodiment is shown in more detail in FIG. 2.

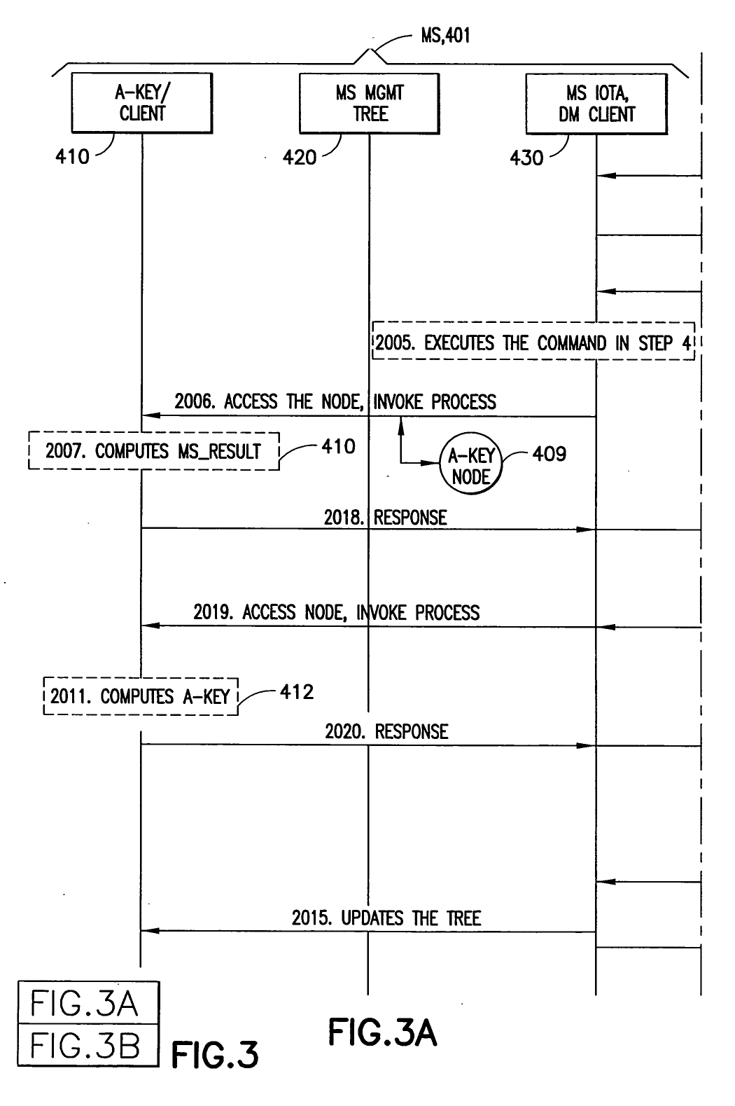

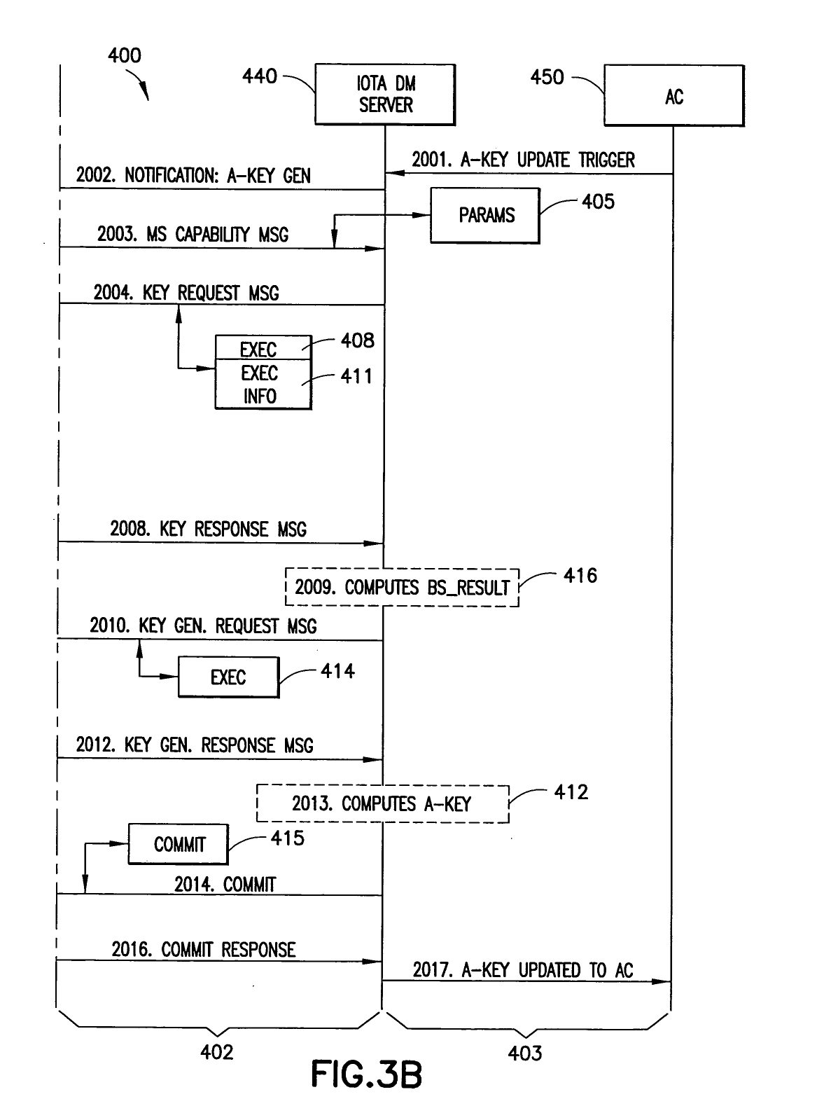

In another exemplary embodiment, the mobile station 100 does not support an IS-683 client. In this exemplary embodiment, the CP requesting server 290 is an AC, and the CP requesting process 295 operates to request updating of the critical parameter but typically does not perform computations. Instead, the IOTA DM server 225 performs certain computations. This exemplary embodiment is shown in more detail in FIG. 3.

The OTA IP I/F 250 is controlled by the IP process 270 to perform functions to communicate using the IP. Similarly, the OTA signaling I/F 255 is controlled by the signaling process 275 to perform functions to communicated using a signaling protocol. The mobile station 100 also comprises an IP process and I/F 146 and a signaling process and I/F 147, each of which performs actions in order to enable their respective transport protocols and to receive and send data using their respective transport protocols. The critical parameter updating process 265 examines (e.g., using the signaling process 275) requests on the communication link defined by a signaling protocol 280 in order to intercept requests for critical parameter updating. In response to receiving a request for critical parameter updating, the critical parameter updating process 265 uses both the IP process 270 and the signaling process 275 to perform functions to update the critical parameter. One exemplary critical parameter is the A-Key, as shown in FIGS. 2 and 3.

Typically, the critical parameter updating process 265 communicates with the MS client 135 to update the critical parameter. In an exemplary embodiment, the MS client 135 uses the MS management tree 140 during updating and the CP client 145 performs computations to update the critical parameter. However, it should be noted that the MS client 135 and CP client 145 can be combined (or further divided), if desired, and memory other than the MS management tree 140 could be used.

Generally, the MS client 135 and CP client 145 reside in memory 130 and are at least partially loaded into MCU 120 for execution. Similarly, the critical parameter updating process 265, IP process 270, and signaling process 275 would be loaded into processor 230 for execution, as would the CP requesting process 295 be loaded into a processor (not shown) for execution. However, the MS client 135, CP client 145, critical parameter updating process 265, IP process 270, IP process 270, signaling process 275, and CP requesting process 295 can be implemented in hardware, such as a Very Large Scale Integrated (VLSI) circuit, implemented in firmware, e.g., programmable logic devices such as gate arrays, implemented in software, or implemented using some combination of two or more of these.

It should be noted that the OTA IP I/F 250 and OTA signaling I/F 255 can be considered to be part of memory 235. Additionally, functions of embodiments of the present invention can be implemented as a signal bearing medium tangibly embodying a program of machine-readable instructions executable by a digital processing apparatus to perform operations to update a security-related parameter such as a critical parameter. The memory 235 and the processor 230 can be singular or distributed.

Furthermore, as is known in the art, the IP process 270, OTA IP I/F 250, the communication link defined by an IP 215, and the IP process and I/F 146 can be considered to be an IP transport 216, where the IP transport 216 comprises the functionality to implement the IP and comprises any hardware, firmware, software or various combinations thereof to implement the IP. Similarly, the signaling process 275, OTA signaling I/F 255, communication link defined by a signaling protocol 280, and the signaling process and I/F 147 can be considered to be a signaling protocol transport 281, where the signaling protocol transport 281 comprises the functionality to implement the signaling protocol and comprises any hardware, firmware, software or various combinations thereof to implement the signaling protocol. Note that the provisioning and device management protocols are in addition to the transport protocols 215, 280. Moreover, the IOTA DM server 225 could include one or more antennas coupled to the OTA IP I/F 250 and OTA signaling I/F 255 and include other transmission and reception devices as is known in the art. Such antennas and interfaces could also be part of the BSC, BTSs, and the like.

Referring now to FIG. 2, an exemplary session diagram is shown illustrative of an embodiment of the invention wherein there is an IS-683 client 310 in the mobile station 301. Entities which may participate in various parts of session 300 are, for instance, A-Key/IS-683 Client 310, MS Management (Mgmt) Tree 320, MS DM Client 330, IOTA DM Server 340, and an OTAF/IS-683 Server 350. The mobile station 301 comprises the A-Key/IS-683 Client 310, the MS Mgmt Tree 320, and the MS IOTA DM Client 330. In terms of FIG. 1, the mobile station 301 is the mobile station 100, the MS Mgmt tree 320 is the MS management tree 140, the A-Key/IS-683 Client 310 is the CP client 145, the IOTA DM Server 340 is the IOTA DM server 225, and the OTAF/IS-683 Server 350 is the CP requesting server 290.

The session 300, which may be considered to be a method for A-key updating, comprises the following steps, in an exemplary embodiment, when there is an IS-683 client (e.g., A-Key/IS-683 Client 310) in the mobile station 301.

In step 1001, the OTAF/IS-683 Server 350 initiates an A-Key update procedure by issuing a “Key Request Message” 306 as described in the IS-683 standard. It should be noted that communications (as indicated by reference 303 in FIG. 2) between the OTAF/IS-683 Server 350 and the IOTA DM Server 340 are performed using a signaling protocol transport 281. As used herein, the term “message” includes any signal capable of being communicated and interpreted. Typically, each message will have a number of fields, each field having a number of bits.

In step 1002, the IOTA DM Server 340 intercepts the “Key Request Message” and buffers this message. The IOTA DM Server 340 intercepts the “Key Request Message” by determining that the message has been made and by packaging the message as described in reference to step 1003. It should be noted that the mobile station 301, in an exemplary embodiment, does not receive the “Key Request Message” through a signaling protocol, and instead communications are performed between the IOTA DM server 340 and the mobile station 301. The IOTA DM Server 340 then sends a notification to the MS IOTA DM Client 330. This message is a Package #0 message in the DM protocol, and the message acts as a trigger. For instance, this message can carry the identification “A-KEY GEN,” by which the MS IOTA DM Client 330 identifies the message as a trigger to begin the updating of A-Key. It should be noted that the communications (e.g., as represented by reference 302 in FIG. 2) between the MS IOTA DM Client 330 and the IOTA DM Server 340 are performed using an IP transport 216.

In step 1003, the MS IOTA DM Client 330 responds with an “MS Capability Message.” This is a standard Package #1 message in the DM protocol, but for the specific purpose of A-Key update (e.g., or other critical parameter updates), this message will carry one or more new parameters 305 to identify the capabilities of the MS. The new parameters 305 would include if the mobile station 301 supports the messaging techniques used in session 300 (e.g., if the mobile station 301 comprises an A-Key/IS-683 Client 310 that supports the provisioning protocol defined by the IS-683) or supports the messaging techniques used in session 400 of FIG. 4 (e.g., if the mobile station 301 comprises a generic A-Key client, which does not support the provisioning protocol defined by the IS-683). The IOTA DM Server 340 learns the version of the A-Key in the setup phase of a DM session. This is achieved by including the A-Key Protocol revision number in the Devinfo and sending the revision number (e.g., in parameters 305) to the IOTA DM Server 340 in a Package #1 message.

Additionally, there could be multiple versions of the A-Key 312. Consequently, the parameters 305 should include an indication of the protocol version of the A-Key being established in the session.

In step 1004, after receiving the “MS Capability Message,” the IOTA DM Server 340 can determine which scenario is to be followed, i.e. whether the subsequent messaging scheme is in accordance with session 300 or session 400 of FIG. 4. If the subsequent messaging scheme is to be performed in accordance with session 300, the MS IOTA DM Client 330 creates a new message “IOTA-DM Key Request Message” by encapsulating the “Key Request Message” 306 originated from the OTAF/IS-683 Server 350 as well as additional commands 307. One additional command 307 is the standard “Exec” command 308 in the DM protocol. But here the “Exec” command 308 is executed on a special node, called the A-Key node 309, in the MS Management Tree 320. The “Exec” command 308 is defined to cause the mobile station 301 to compute the MS_RESULT value 310, as described below. The A-Key node 309 is set up and modified by the MS IOTA DM Client 330. The A-Key node 309 corresponds to the A-Key in the mobile station 301. Since the A-Key is typically stored in permanent storage (e.g., of memory 130 of FIG. 1) of the mobile station 301, in the Removable User Identity Module (R-UIM/UICC (e.g., of memory 130 of FIG. 1), or in a Universal Integrated Circuit Card (UICC) (e.g., of memory 130 of FIG. 1), this A-Key node 309 in the MS Mgmt Tree 320 is a dummy node. The A-Key node 309 does not store the value of the A-Key, but instead points to a process that the “Exec” command 308 should execute upon receiving the “IOTA-DM Key Request Message in step 1004 (e.g., and the “IOTA-DM Key Generation Request Message” in step 1017). In session 300, this process is the A-Key/IS-683 Client 310 running in the mobile station 301. The “Key Request Message” 306 received at the MS IOTA DM Client 330 can be stored in a temporary leaf node 313 of the A-Key node 309, from where the invoked A-Key/IS-683 Client 310 can access the “Key Request Message” 306.

It should be noted that the double arrow in step 1004 (e.g., and steps 1009, 1017, 1021, and 1024) indicates that a request-response combination is performed.

In step 1005, upon receiving the “IOTA-DM Key Request Message” the MS IOTA DM Client 330 executes the commands specified in the “IOTA-DM Key Request Message.” This involves executing the “Exec” command 308 on the A-Key node 309 in the MS Mgmt Tree 320. This execution results in passing the encapsulated “Key Request Message” 306 to the invoked (step 1006) A-Key/IS-683 Client 310. Note that communications between the MS IOTA DM client 530 and the A-Key IS-683 client are performed using the provisioning protocol defined in an IS-683 standard (e.g., IS-683-A and later revisions), entitled “Over-the Air Service Provisioning of Mobile Stations in Spread Spectrum Systems” (1998).

In step 1007, the A-Key/IS-683 Client 310 calculates the MS_RESULT value based on the input parameters in the encapsulated “Key Request Message” 306. The algorithm described in Section 5.1 of C.S0016 Over-the-Air Service Provisioning of Mobile Stations in Spread Spectrum Systems, 3GPP2 (March 2003), the disclosure of which is already incorporated by reference, is followed in an exemplary embodiment for computing the MS_RESULT value 310.

In step 1008, the A-Key/IS-683 Client 310 sends the “Key Response Message” which includes the status of the MS_RESULT computation. If an error occurred, the error code is sent in the response as described in C.S0016 Over-the-Air Service Provisioning of Mobile Stations in Spread Spectrum Systems, 3GPP2 (March 2003).

In step 1009, the “Key Response Message” is intercepted by the MS IOTA DM Client 330 and is encapsulated by the MS IOTA DM Client 330 in a DM protocol message called “IOTA-DM Key Gen. Response Message.” One way is to store the “Key Response Message” in a temporary leaf node 313 associated with the A-Key node 309 in the MS Mgmt Tree 320 from where the MS IOTA DM Client 330 can access it for encapsulation. Also in step 1009, the MS IOTA DM Client 330 sends the encapsulated “IOTA-DM Key Response Message” to the IOTA DM Server 340.

In step 1010, the IOTA DM Server 340 forwards the encapsulated message to the OTAF/IS-683 Server 350.

In step 1011, the OTAF/IS-683 Server 350 calculates a BS_RESULT value 316 following the algorithm in section 5.2 of C.S0016 Over-the-Air Service Provisioning of Mobile Stations in Spread Spectrum Systems, 3GPP2 (March 2003) and sends (step 1012) the BS_RESULT to the mobile station 301 in the “Key Generation Request Message.”

In step 1013, the IOTA DM Server 340 intercepts and encapsulates the “Key Generation Request Message” in a DM Protocol message and sends it to the MS IOTA DM Client 330 in the “IOTA-DM Key Generation Request Message.” This message also carries an “Exec” 311 command defined to invoke (e.g., using the A-Key node 309) the A-Key/IS-683 Client 310 to compute the A-Key 312. The “Exec” command 311 also contains the BS_RESULT value 316.

In step 1014, executing the “Exec” command 311 results in invoking the A-Key/IS-683 Client 310. In step 1015, the A-Key/IS-683 Client 310 computes the A-Key 312 from the BS_RESULT value 316.

In step 1015, the A-Key/IS-683 Client 310 now sends the MS_RESULT value 310, computed in step 1007, in the “Key Generation Response Message.” The message is encapsulated by the MS IOTA DM Client 330 in an IOTA-DM Key Generation Response Message.” Encapsulation can be achieved by the A-Key/IS-683 Client 310 first storing the “Key Generation Response Message” in a temporary leaf node 313 off the A-Key node 609 and then the MS IOTA DM Client 330t accessing the temporary leaf node 313. In step 1017, the MS IOTA DM Client 330 communicates the “IOTA-DM Key Generation Response Message” to the IOTA DM Server 340.

In step 1018, the IOTA DM Server 340 forwards the MS_RESULT value to the OTAF/IS-683 Server 350 by using a “Key Generation Response Message.” In step 1019, the OTAF/IS-683 Server 350 computes the A-Key 312 and issues a “Commit” message in step 1020.

In step 1021, IOTA DM Server 340 intercepts the “Commit” message and directs the “Commit” message 314 to the MS IOTA DM Client 330 using an “IOTA-DM Commit” message. In step 1022, the MS IOTA DM Client 330 forwards the “Commit” message 314 to the A-Key/IS-683 Client 310. On receiving the “Commit” message 314, the A-Key/IS-683 Client 310 stores (step 1026) the A-Key 312 in a permanent memory (e.g., as part of the memory 130).

In step 1023, the A-Key/IS-683 Client 310 now sends a “Commit Response” message. In step 1024, the “Commit Response” message is encapsulated by the MS IOTA DM Client 330 into the “IOTA-DM Commit Response” message and communicated (step 1024) by the MS IOTA DM Client 330 to the IOTA DM Server 340. The IOTA DM Server 340 forwards the “Commit Response” message to the OTAF/IS-683 Server 350 in step 1025.

The OTAF/IS-683 Server 350 can now update the A-Key in the AC. This step is not shown in FIG. 2.

Turning now to FIG. 3, a session diagram is shown that is illustrative of an embodiment of the invention wherein the mobile station 401 does not Support IS-683 Client Entities that may participate in various parts of session 400 are, for example, A-Key Client 410, MS Management (Mgmt) Tree 420, MS IOTA DM Client 430, IOTA DM Server 440, and AC 450. The A-Key client 410 may have to be created for the exemplary embodiment shown in FIG. 4. The mobile station 401 comprises the A-Key Client 410, MS Mgmt Tree 420, and the MS IOTA DM Client 430. In terms of FIG. 1, the mobile station 401 is mobile station 100, the A-Key Client 410 is the CP client 145, the MS Mgmt Tree 420 is the MS management tree 140, the MS IOTA DM Client 430 is the MS client 135, the IOTA DM Server 440 is the IOTA DM server 225, and AC 450 is the CP requesting server 290.

Session 400, which may be considered to be a method for updating a critical parameter, comprises the following steps, in an exemplary embodiment, when there the mobile station 401 does not support an IS-683 client.

In step 2001, the AC 450 initiates a trigger, in the form of a “A-Key update trigger” message, to update the A-Key in the mobile station 401. It should be noted that communications (as indicated by reference 403 in FIG. 3) between the AC 450 and the IOTA DM Server 440 are performed using a signaling protocol transport 281. The IOTA DM Server 440 intercepts the trigger to update the A-Key by determining that the trigger has occurred and by packaging the trigger in a key request message in step 2004. The trigger is typically defined by some provisioning protocol. It should be noted that the mobile station 401, in an exemplary embodiment, does not receive the “A-Key update trigger” message through a signaling protocol, and instead communications are performed between the IOTA DM server 440 and the mobile station 401.

In step 2002, the IOTA DM Server 440 begins a notification-initiated session by sending a “Notification” message with data “A-KEY GEN.” It should be noted that the communications (e.g., as represented by reference 402 in FIG. 3) between the IOTA DM Server 440 and the AC 450 are performed using an IP transport 216.

In step 2003, the MS IOTA DM Client 430 responds with a Package #1 message, the “MS Compatibility Message,” carrying the capability information, in parameters 405, for the mobile station 410. The parameters 405 enable the IOTA DM Server 440 to select a subsequent messaging scheme according to the capabilities of the mobile station 401. As described above, the IOTA DM Server 440 can determine the subsequent messaging scheme to be used for A-Key updating, based on the parameters 405. Steps 2004 to 2017 assume that the mobile station 401 supports the device management protocol of SyncML DM, although other device management protocols may also be supported.

Additionally, there could be multiple versions of the A-Key 312. Consequently, the parameters 305 should include an indication of the protocol version of the A-Key being established in the session.

In step 2004, the IOTA DM Server 440 creates a “Key Request Message” and sends the “Key Request Message” to the MS IOTA DM Client 430 in a DM Protocol [2] message. The message includes, in an exemplary embodiment, the input parameters mentioned in section 5.1.2 of C.S0016 Over-the-Air Service Provisioning of Mobile Stations in Spread Spectrum Systems, 3GPP2 (March 2003).

In step 2005, the MS IOTA DM Client 430 executes the “Exec” command 408 in the “Key Request Message” and accesses the A-Key node 409 in step 2006. The “Exec” command 408 carries execution information 411 about the process to be invoked for calculating A-Key, and the process is typically performed by the A-Key Client 410, invoked in step 2006. A pointer to the process is stored in the A-Key node 409. The process can, however, be integrated to the MS IOTA DM Client 430, in which case a separate A-Key Client 410 is not required. The execution information 411 is provided as input parameters to the A-Key client 410. The “Exec” command 408 is defined to cause the mobile station 401 to compute the MS_RESULT value 410, as described below.

In step 2007, the A-Key Client 410 computes the MS_RESULT value 410. In step 2008, a result code is sent in the “Key Response Message” by the MS IOTA DM Client 430 to the IOTA DM Server 440. In step 2018, the A-Key client 410 responds that the MS_RESULT 410 has been generated.

In step 2009, the IOTA DM Server 440 computes the BS_RESULT value 416. See, for instance, procedures in 5.2.1 of C.S0016 Over-the-Air Service Provisioning of Mobile Stations in Spread Spectrum Systems, 3GPP2 (March 2003).

In step 2010, the IOTA DM Server 440 sends the BS_RESULT value 216 to the MS IOTA DM Client 430 in a “Key Generation Request Message,” which includes an “Exec” command 414. The “Exec” command 414 is defined to cause the mobile station 401 to compute the A-Key 412.

In step 2011, the MS IOTA DM Client 430 passes the BS_RESULT value 216 to the A-Key Client 410 by invoking the A-Key Client 410 using the “Exec” command 414.

In step 2011, the A-Key client 410 computes the A-Key 412 following, in an exemplary embodiment, the algorithm described in section 5.1 of C.S0016 Over-the-Air Service Provisioning of Mobile Stations in Spread Spectrum Systems, 3GPP2 (March 2003), based on the execution information 411 received in step 2004 and the BS_RESULT value 416 received in step 2010. The value of the A-Key 412 can be stored in a temporary location in the MS IOTA DM Client 430. In step 2020, the A-Key Client 410 responds to the MS IOTA DM Client 430 that the A-Key has been computed.

In step 2012, the MS IOTA DM Client 430 sends a “Key Generation Response Message” to the IOTA DM Server 440. The MS_RESULT value 410 computed in step 2007 is sent in the “Key Generation Response Message” to the IOTA DM Server 440.

In step 2013, the IOTA DM Server 440 computes the A-Key 412 based on the MS_RESULT value 410, following (illustratively) the algorithm in section 5.2 of C.S0016 Over-the-Air Service Provisioning of Mobile Stations in Spread Spectrum Systems, 3GPP2 (March 2003).

In step 2014, the IOTA DM Server 440 sends a “Commit” message to the MS IOTA DM Client 430 containing a commit request 415. In response to receipt of the commit request 415, the MS IOTA DM Client 430 invokes (step 2015) the A-Key client 410 to store the A-Key 412 stored in a temporary node of the MS IOTA DM Client 430 to permanent memory, as e.g. A-KEYp (not shown), and removes the A-Key 412 from temporary storage.

In step 2016, the MS IOTA DM Client 430 sends the status of commit request 415 in a Commit Response message. In step 2017, the IOTA-DM server 440 communicates the updated A-Key 415 to the AC 450.

Turning now to FIG. 4, FIG. 4 is simplified block diagram of a wireless communication system 1, specifically a CDMA 2000 1x network that is suitable for use in practicing certain teachings of this invention. The wireless network 1 is an example of a network suitable for implementing, for instance, the session diagrams of FIGS. 2 and 3 (in particular, FIG. 2). A description of FIG. 4 will be provided in order to place an embodiment of this invention into a suitable technological context. However, it should be appreciated that the specific network architecture and topology shown in FIG. 4 is not to be construed in a limiting sense upon this invention, as this invention could be practiced in networks having an architecture and topology that differs from that shown in FIG. 4. For instance, the general concepts of this invention may be practiced as well in a TDMA-based mobile IP network, and is thus not limited for use only in a CDMA network. In general, this invention will find utility in wireless technologies where the MS context is partitioned into static and dynamic contexts. As such, while reading the ensuing description it should be noted that while some aspects of the description are specific to a CDMA network, such as the point-to-point protocol (PPP) context, the description is not intended to be read in a limiting sense upon the implementation, use and practice of this invention.

The wireless communication system 1 shown in FIG. 4 includes at least one MS 10 (e.g., mobile station 301 of FIG. 2). As described above, the MS 10 may be or may include a cellular telephone, or any type of mobile terminal (MT) or mobile node (MN) having wireless communication capabilities including, but not limited to, portable computers, personal data assistants (PDAs), Internet appliances, gaming devices, imaging devices and devices having a combination of these and/or other functionalities. The MS 10 is assumed to be compatible with the physical and higher layer signal formats and protocols used by a network 12, and to be capable of being coupled with the network 12 via a wireless link 11. In the presently preferred embodiments of this invention, the wireless link 11 is a radio frequency (RF) link, although in other embodiments the wireless link 11 could be, for instance, an optical link.

In a conventional sense, the network 12 includes a mobile switching center (MSC) 14 coupled through an IS-41 Map interface to a visitor location register (VLR) 16. The VLR 16 in turn is coupled through an IS-41 Map interface to a switching system seven (SS-7) network 18 and thence to a home location register (HLR) 20 that is associated with a home access provider network of the MS 10. The MSC 14 is also coupled through an A1 interface (for circuit switched (CS) and packet switched (PS) traffic) and through an A5/A2 interface (CS services only) to a first radio network (RN) 22A. The first RN 22A includes a base station (BS) 24A that includes a base transceiver station (BTS) and a base station center (BSC) that is coupled through an A8/A9 interface to a Packet Control Function (PCF) 26A. The PCF 26A is coupled via an R-P (PDSN/PCF) interface 27 (also called an A10/A11 interface) to a first packet data service node (PDSN) 28A and thence to an IP network 30 (via a Pi interface). The PDSN 28A is also shown coupled to a visited access, authorization and accounting (AAA) node 32 via a Pi and a remote authentication dial-in service (RADIUS) interface, that in turn is coupled to the IP network 30 via a RADIUS interface. Also shown coupled to the IP network 30 via RADIUS interfaces are a Home IP network AAA node 34 and a Broker IP network AAA node 36. A home IP network/home access provider network/private network Home Agent 38 is coupled to the IP network via a Mobile IPv4 interface. In accordance with RFC3220, the Home Agent 38 is a router on the home network of a mobile node (the MS 10 in this description) that tunnels datagrams for delivery to the mobile node when it is away from home, and that maintains current location information for the mobile node.

Also shown in FIG. 4 is a second RN 22B that is coupled to the first RN 22A via an A3/A7 interface. The second RN 22A includes a BS 24B and a PCF 26B and is coupled to a second PDSN 28B. The PDSN 28A and the PDSN 28B are coupled together through a P-P interface 29 (PDSN to PDSN interface, defined in IS835C).

For the purposes of description of an exemplary embodiment of this invention, and not by way of limitation, the first PDSN 28A is considered to be the anchor PDSN (a-PDSN), and the second PDSN 28B is considered to be the target PDSN (t-PDSN), for the MS 10. In like manner, the associated BSs and PCFs can be assumed to be the anchor BS 24A and anchor PCF 26A, and the target BS 24B and target PCF 26B.

It should be noted, however, that there may be a plurality of BSs 24 connected to a single PCF 26 (defining a BS subnet), and that there may be a plurality of PCFs 26 within a given network all connected to a single PDSN 28. It may thus be the case that the source or anchor BS and the target BS may exist in the same BS subnet. Also, the source or anchor and target PCF may exist in the same network served by a single PDSN 28.

In the example of FIG. 1, the OTAF/IS-683 server 350 resides in the network 12 and the IOTA DM server 340 is coupled to the IP network 30 and to the network 12. The OTAF/IS-683 server 350 is coupled to (typically through network 12) the MSC 14, the VLR 16, the HLR 20, and the IOTA DM server 340. The IOTA DM server 340 is also coupled to a CDMA AC, such as Home IP network AAA node 34 and/or visited AAA node 32. The network 12 (e.g., and interfaces for the network 12) implements the signaling protocol, while the IP network 30 (e.g., and interfaces for the IP network 30) implements the IP. The IOTA DM server 340 acts as an interface between the IP network 30 and the network 12.

Although the above description relates mainly to the critical parameter of the A-key, other security-related parameters may also be updated using the present invention. For instance, there are several Security Keys used in CDMA, and many of these Security Keys are established using the OTA signaling protocol. These Security Keys could also be updated using embodiments of the present invention.

It should be noted that the set of messages (e.g., as shown in FIGS. 2 and 3) between the IOTA DM server and the IOTA DM client, where the set of messages is defined to cause the mobile station to update the critical parameter, could have fewer or more messages and the messages could be arranged differently. For example, in FIG. 2, the mobile station could be sent the BS_RESULT along with two commands, one command to cause the mobile station to compute the MS_RESULT and one command to cause the mobile station to compute the A-Key. Thus, the set of messages could be simplified to possibly a single message or several messages. However, this also depends on the provisioning and/or device management protocols being used.

As described above, one exemplary embodiment is related to the IP-based Over-The-Air (IOTA) Device Management (DM) work item in the 3GPP2 Technical Specification Group for Service and system aspects (TSG-S) standard specification, Project Number 3-0187, Telecommunications Industry Association (TIA)-1059-IP-based Over the Air Device Management for CDMA2000 Systems. See also, Third Generation Partnership Project (3GPP2), Project Number S.R0101-0, Version 1.0, 22 Apr. 2004, entitled, “IOTA Device Management for CDMA2000 Systems Stage 1 Requirements.” However, the techniques presented herein may be applied to other management and transport protocols. Additionally, it should be noted that a single protocol can comprise multiple other protocols. For example, the IOTA DM protocol defines messaging schemes for device management and also defines that IP is to be used. Thus, a message may be expressed in multiple protocols.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the present invention, and not in limitation thereof.

1. A method performed on a first server for communicating with a mobile station in order for the mobile station to update a security-related parameter, comprising:
determining that a request expressed in a first protocol has been made by a second server for updating the security-related parameter on the mobile station; and
in response to determining, packaging the request in a message expressed in a second protocol and communicating the message to the mobile station.

2. The method of claim 1, wherein the first protocol comprises a signaling protocol and the second protocol comprises an internet protocol.

3. The method of claim 2, wherein the signaling protocol further comprises an over-the-air management protocol, and wherein the internet protocol further comprises an over-the-air internet protocol.

4. The method of claim 3, wherein the over-the-air management protocol comprises an IS-683 management protocol, and wherein the over-the-air internet protocol further comprises an Internet Protocol (IP)-based Over-The-Air (IOTA) Device Management protocol.

5. The method of claim 1, further comprising determining that the mobile station has updated the security-related parameter, and communicating a response expressed in the second protocol to the second server, the response indicating that the mobile station has updated the security-related parameter.

6. The method of claim 1, wherein:
the first and second protocols comprise different transport protocols;
the request is further expressed in a first management protocol; and
packaging further comprises packaging the request in the message, where the message is expressed in a second management protocol in addition to the second protocol.

7. The method of claim 1, wherein:
the first and second protocols comprise different transport protocols;
the request comprises a trigger to cause the mobile station to begin operations to update the security-related parameter; and
packaging further comprises packaging the request in the message, where the message is expressed in a management protocol in addition to the second protocol.

8. The method of claim 1, wherein the security-related parameter comprises an authentication key.

9. The method of claim 1, wherein the security-related parameter comprises a security key.

10. The method of claim 1, wherein:
the security-related parameter comprises one of an authentication key or a security key; and
the security-related parameter is defined by a Code-Division Multiple Access (CDMA) standard.

11. The method of claim 1, further comprising communicating at least one additional message expressed in the second protocol to the mobile station, the at least one additional message comprising at least one command defined to cause the mobile station to determine the security-related parameter.

12. The method of claim 1, further comprising communicating a first message and a second message expressed in the second protocol with the mobile station, the first message comprising a first command defined to cause the mobile station to compute a first value, and the second message comprising a second value and a second command defined to cause the mobile station to compute the security-related parameter by using the first and second values.

13. The method of claim 1, wherein:
the message is a first message; and
the method further comprises:
receiving a second message comprising an indication of a version of the security-related parameter, the second message expressed in the second protocol; and
communicating a third message, expressed in the first protocol and comprising the indication, to the second server.

14. The method of claim 1, further comprising receiving an additional message comprising at least one parameter, the at least one parameter indicating whether or not the mobile station supports a certain provisioning protocol.

15. The method of claim 14, further comprising:
in response to the at least one parameter indicating that the mobile station does support the certain provisioning protocol, performing a first collection of steps; and
in response to the at least one parameter indicating that the mobile station does not support the certain provisioning protocol, performing a second collection of steps.

16. The method of claim 15, wherein the message is a first message, and wherein the second collection of steps comprises:
receiving a second message expressed in the second protocol from the mobile station, the second message comprising a first value;
computing a second value; and
computing, in response to the second message, the security-related parameter based on the first and second values; and
communicating a response expressed in the first protocol to the second server, wherein the response comprises the security-related parameter.

17. The method of claim 16, wherein the second collection of steps further comprises:
receiving a third message expressed in the second protocol, the third message comprising an indication that the first value has been computed by the mobile station; and
computing a second value further comprises computing, in response to the third message, the second value.

18. The method of claim 15, wherein the message is a first message, and wherein the first collection of steps comprises:
receiving from the mobile station a second message, expressed in the second protocol, comprising a first value;
communicating, in a third message expressed in the first protocol, the first value to the second server; and
receiving, in a fourth message expressed in the first protocol, a second value from the second server; and
communicating, in response to receiving the second value, a fifth message expressed in the second protocol to the mobile station, the fifth message comprising the second value.

19. The method of claim 18, wherein the first collection of steps further comprises:
receiving a sixth message expressed in the second protocol from the mobile station, the sixth message comprising an indication that the first value has been determined by the mobile station; and
in response to the sixth message, communicating the indication to the server in a seventh message expressed in the first protocol.

20. The method of claim 1, wherein:
the message is a first message; and
the method further comprises:
communicating to the mobile station a second message expressed in the second protocol, the second message comprising a first command defined to cause the mobile station to compute a first value;
receiving a third message expressed in the second protocol from the mobile station, the third message comprising the first value;
computing a second value;
computing, in response to the third message, the security-related parameter based on the first and second values; and
communicating a fourth message expressed in the second protocol to the mobile station, the fourth message comprising the second value and a second command, the second command defined to cause the mobile station to compute the security-related parameter using the first and second values.

21. The method of claim 20, further comprising:
receiving a fifth message expressed in the second protocol, the fifth message comprising an indication that the first value has been computed by the mobile station; and
computing a second value further comprises computing, in response to the fifth message, the second value.

22. The method of claim 1, wherein:
the message is a first message; and
the method further comprises:
communicating to the mobile station a second message expressed in the second protocol, the second message comprising a first command defined to cause the mobile station to compute a first value;
receiving a third message expressed in the second protocol, the third message comprising the first value;
communicating, using a fourth message expressed in the first protocol, the first value to the second server;
receiving, in a fifth message expressed in the first protocol, a second value from the second server;
communicating, in response to receiving the second value, a sixth message to the mobile station, the sixth message expressed in the second protocol and comprising the second value and a second command, the second command defined to cause the mobile station to compute the security-related parameter using the first and second values.

23. The method of claim 18, further comprising:
receiving, using the second transport, a seventh message from the mobile station, the seventh message comprising an indication that the first value has been determined by the mobile station; and
in response to the seventh message, communicating the indication to the server in an eighth message expressed in the first protocol.

24. An apparatus for communicating with a mobile station in order for the mobile station to update a security-related parameter, the apparatus comprising:
at least one memory; and
at least one processor coupled to the at least one memory, the at least one processor configured to perform the steps of:
determining that a request expressed in a first protocol has been made by a server for updating the security-related parameter on the mobile station; and
in response to determining, packaging the request in a message expressed in a second protocol and communicating the message to the mobile station.

25. An apparatus for communicating with a mobile station in order for the mobile station to update a security-related parameter, comprising:
means for determining that a request expressed in a first protocol has been made by a server for updating the security-related parameter on the mobile station; and
means, responsive to the means for determining, for packaging the request in a message expressed in a second protocol and communicating the message to the mobile station.

26. The apparatus of claim 25, wherein:
the first and second protocols comprise different transport protocols;
the request is further expressed in a first management protocol; and
the means for packaging further packages the request in the message, where the message is expressed in a second management protocol in addition to the second protocol.

27. A signal bearing medium tangibly embodying a program of machine-readable instructions executable by a digital processing apparatus to perform operations to communicate with a mobile station in order for the mobile station to update a security-related parameter, the operations comprising:
determining that a request expressed in a first protocol has been made by a second server for updating the security-related parameter on the mobile station; and
in response to determining, packaging the request in a message expressed in a second protocol and communicating the message to the mobile station.

28. A method performed on a management server for communicating with a mobile station in order for the mobile station to update a security-related parameter, comprising:
receiving from a second server a first message expressed in a signaling protocol, the first message comprising a first request message, the first request message expressed in a first data management protocol and defined to request updating the security-related parameter on the mobile station; and
in response to determining, packaging the first request message in a second request message expressed in a second data management protocol, and communicating the second request message in a second message expressed in an internet protocol to the mobile station.

29. A method performed on a mobile station for updating a security-related parameter, comprising:
receiving a message expressed in a first protocol from a server and comprising a request for the mobile station to update the security-related parameter, the request expressed in a second protocol; and
performing, in response to the message, at least one operation in order to update the security-related parameter.

30. The method of claim 29, further comprising communicating an additional message expressed in the first protocol to the server, the additional message indicating the security-related parameter has been updated.

31. The method of claim 29, wherein the first protocol comprises an internet protocol and the second protocol comprises a management protocol.

32. The method of claim 31, wherein the internet protocol comprises an over-the-air internet protocol.

33. The method of claim 31, wherein the over-the-air internet protocol further comprises an Internet Protocol (IP)-based Over-The-Air (IOTA) Device Management protocol, and wherein the management protocol comprises an IS-683 over-the-air management protocol.

34. The method of claim 31, wherein the management protocol is a first management protocol and wherein the message is further expressed in a second management protocol.

35. The method of claim 34, wherein the first and second management protocols are different over-the-air management protocols.

36. The method of claim 29, wherein:
the first protocol comprises a transport protocol; and
the request defines a trigger to cause the mobile station to begin operations to update the security-related parameter.

37. The method of claim 29, wherein the security-related parameter comprises an authentication key.

38. The method of claim 29, wherein the security-related parameter comprises a security key.

39. The method of claim 38, wherein the security key is defined by a Code-Division Multiple Access (CDMA) standard.

40. The method of claim 29, wherein the message is a first message, and wherein the method further comprises communicating a second message expressed in the first protocol to the server, the second message comprising at least one parameter, the at least one parameter indicating whether or not the mobile station supports a certain provisioning protocol.

41. The method of claim 29, wherein:
the method further comprises receiving at least one command message from the server, the at least one command message comprising at least one command defined to cause the mobile station to determine the security-related parameter; and
performing at least one operation further comprises performing, in response to the at least one command message, at least one operation defined by the at least one command in order to determine the security-related parameter.

42. The method of claim 29, wherein:
the method further comprises receiving a first message expressed in the first protocol from the server, the first message comprising a first command defined to cause the mobile station to compute a first value; and
performing at least one operation further comprises performing at least one first operation defined by the first command in order to compute the first value.

43. The method of claim 42, further comprising communicating a second message expressed in the first protocol to the server, the second message comprising an indication that the first value has been computed.

44. The method of claim 42, wherein:
the method further comprises receiving a second message expressed in the second protocol from the server, the second message comprising a second value and a second command defined to cause the mobile station to compute the security-related parameter by using the first and second values; and
performing at least one operation further comprises performing at least one second operation defined by the second command to compute the security-related parameter, the at least one second operation using the first and second values during the computation of the security-related parameter.

45. The method of claim 44, wherein one or more of performing at least one first operation and performing at least one second operation uses at least one node in a management tree to store information.

46. The method of claim 45, wherein the node is a temporary node and wherein performing at least one operation further comprises deleting the at least one node in response to performing a predetermined operation of the at least one first operation and the at least one second operation.

47. A mobile station that updates a security-related parameter, the mobile station comprising:
at least one memory; and
at least one processor coupled to the at least one memory, the at least one processor configured to perform the steps of:
receiving a message expressed in a first protocol from a server and comprising a request for the mobile station to update the security-related parameter, the request expressed in a second protocol; and
performing, in response to the message, at least one operation in order to update the security-related parameter.

48. The mobile station of claim 47, wherein the at least one memory further comprises a signal bearing medium tangibly embodying a program of machine-readable instructions executable by the at least one processor to perform the receiving and performing operations.

49. A mobile station that updates a security-related parameter, comprising:
means for receiving a message expressed in a first protocol from a server and comprising a request for the mobile station to update the security-related parameter, the request expressed in a second protocol; and
means for performing, in response to the message, at least one operation in order to update the security-related parameter.

50. The apparatus of claim 49, wherein the first protocol comprises an internet protocol, the second protocol comprises a first management protocol, and wherein the message is further expressed in a second management protocol.
